(19) United States
(12) Patent Application Publication
(10) Pub. No.: US 2026/0089818 A1
(43) Pub. Date: Mar. 26, 2026

(54) LIGHTING CONTROLLER WITH MULTIPLEXED MUTLIMODE DIMMING INTERFACE

(71) Applicant: UBICQUIA, INC., FORT LAUDERDALE, FL (US)

(72) Inventor: Wei Xiong, Madison, AL (US)

(21) Appl. No.: 19/334,946

(22) Filed: Sep. 21, 2025

Related U.S. Application Data
(60) Provisional application No. 63/697,583, filed on Sep. 22, 2024.

(51) Int. Cl. H05B 45/12; H05B 45/325; H05B 47/11; H05B 47/16; H05B 47/18

(52) U.S. Cl. CPC H05B 45/12; H05B 45/325; H05B 47/11; H05B 47/16; H05B 47/183; H05B 47/184

(57) ABSTRACT

A lighting controller includes a microcontroller, a first dimming circuit utilizing a DALI protocol, a second dimming circuit utilizing a non-DALI dimming technology, a DALI bus over which DC power is supplied to the first dimming circuit and that is used by the first dimming circuit to communicate an output dimming signal to the lighting fixture, and a multiplexing circuit (MUX) operable to couple an output of either the first dimming circuit or the second dimming circuit to the controller's dimming output. The MUX includes a first set of diodes to isolate the second dimming circuit from the DALI bus when the second dimming circuit is deactivated and the first dimming circuit is activated. The first dimming circuit includes a second set of diodes to isolate the second dimming circuit from the DALI bus when the first dimming circuit is deactivated and the second dimming circuit is activated.

### CROSS-REFERENCE TO RELATED APPLICATIONS

The present application claims the benefit of and priority upon U.S. Provisional Patent Application No. 63/697,583, which was filed on Sep. 22, 2024, and is incorporated herein by this reference as if fully set forth herein.

### TECHNICAL FIELD

The present disclosure generally relates to energy management and control systems for controlled devices such as lighting fixtures. More particularly, but not exclusively, the present disclosure relates to a lighting controller with a multiplexed multimode dimming interface.

### BACKGROUND

The control of light-emitting diodes (LEDs) is different from that of traditional lighting. The LED light source of the same power uses schemes and different current and voltage parameters, so its internal wiring structure and circuit distribution are also different, which leads to different dimming drives of the light sources. The requirements are also different. Therefore, the mismatch between the control system and the light source appliances has become a common problem in the industry. At the same time, the diversification of LEDs also poses higher challenges to the control system. If the control system and lighting equipment are not matched, it may cause the lights to go out or flicker and may cause damage to the LED drive circuit and light source. The issue can even become more complex when multiple dimming control schemes are used on the same LED light fixture.

A lighting control protocol is a set of rules used for communication between lighting control devices, like ballasts, sensors, or motion detectors. The commonly used lighting control protocols are the Digital Illumination Interface Alliance's Digital Addressable Lighting Interface (DALI) protocols, 0-10V or 1-10V (collectively referred to as 0/1-10V) analog dimming, digital multiplex (DMX), and pulse width modulation (PWM). The two primary types of protocols are analog and digital. Analog protocols are usually one-way (unidirectional), allowing no feedback from interfaces, luminaires, or devices. Digital protocols are either one-way or two-way. Two-way (bidirectional) protocols allow data, reliability rules, and other information to be exchanged between the luminaire and the device. With respect to dimming, there are five common dimming methods on the market, namely, DALI dimming, silicon-controlled rectifier (SCR) dimming, PWM dimming, 0/1-10V dimming, and DMX dimming.

The DALI standard defines a DALI network, including a maximum of 64 devices (with independent addresses), 16 groups, and 16 scenes. Different lighting units on the DALI bus can be flexibly grouped to achieve different scene control and management. In practical applications, a typical DALI system application can control 40-50 lamps, which can be divided into 16 groups, and can handle some controls/scenarios in parallel.

The advantage of DALI is that it has a special agreement to enhance the interoperability of products between different brands, and each DALI device has a separate address code, which can truly be controlled by a single lamp. Two-way communication facilitates timely inquiry and understanding of equipment status and information.

SCR or thyristor dimming has been applied to incandescent lamps and energy-saving lamp dimming methods earlier, and it is currently the most widely used dimming method for LED dimming. Thyristor dimming is a kind of physical dimming. Starting from AC phase 0, the input voltage is chopped, and there is no voltage input until the thyristor is turned on. The working principle is to cut the input voltage waveform through the conduction angle to produce a tangential output voltage waveform. Applying the principle of tangential direction can reduce the effective value of the output voltage, thereby reducing the power of ordinary loads (resistive loads). Thyristor dimmers have the advantages of high adjustment accuracy, high efficiency, small size, light weight, and easy long-distance manipulation, and occupy a dominant position in the market.

PWM dimming technology realizes the control of the analog circuit through the on-off control of the inverter circuit switch. The output waveform of PWM technology is a series of pulses of equal size to replace the required waveform. A sine wave as an example, that is, make the equivalent voltage of this series of pulses a sine wave, and the output pulse is as smooth as possible and has less low-order harmonics. According to different needs, the width of each pulse can be adjusted accordingly to change the output voltage or output frequency and then achieve the control of the analog circuit. In short, PWM is a method of digitally encoding analog signal levels.

Through the use of high-resolution counters, the occupancy ratio of the PWM square wave is modulated to encode the level of a specific analog signal. The PWM signal is still digital, because at any given moment, the full-scale DC power supply is either completely present or completely absent. The voltage or current source is applied to the analog load in a repetitive pulse sequence of on or off. When the power is on, it is when the DC power supply is added to the load, and when the power is off, it is when the power supply is disconnected.

If the frequency of brightness and darkness exceeds 100 Hz, the human eye sees the average brightness, not the LED flickering. PWM adjusts the brightness by adjusting the time ratio of light and dark. In a PWM period, because the human eye flickers the light within 100 Hz, perceived brightness is a cumulative process—that is, the greater the proportion of the bright time in the entire cycle, the brighter the human eye feels.

With respect to 0/1-10V dimming, there are two independent circuits in the 0/1-10V dimming device, one is an ordinary voltage circuit used to turn on or off the power supply to the lighting equipment, and the other is a low-voltage circuit, which provides a reference voltage to tell the lighting equipment to adjust light level. In the past, 0/1-10V dimming was used to control the dimming of fluorescent lamps. Now, because an LED driver module has a power supply and a special control circuit, the 0/1-10V dimmer can also support a large number of LED lights.

With 1-10V dimming, only the dimmer is 1-10V. When the resistance dimmer is adjusted to the minimum 1V, the output current is 10% (not a fixed value). If the output current is 100% at 10V, the brightness will also be 100%.

There are two 0-10V standards currently in use. The original 0-10V control was employed to control lights for the stage or theatre. Another 0-10V control method was created and is still used as a standard for control of fluorescent dimming ballasts.

With regard to DMX dimming, DMX512 is a standard protocol for digital communication networks, usually used to control stage lighting and special effects. Compared with a traditional analog dimming system, a digital lighting system based on the DMX512 control protocol can provide powerful control functions for large and medium-sized indoor and outdoor LED lighting systems.

Choosing an ideal lighting control protocol for any project is essential when designing an intelligent lighting control system. Protocols are rules that govern how control devices interact and behave in a lighting network. Hence, lighting control protocol selection is an important decision point because it is a prominent factor determining the overall cost and project quality.

Multiplexing and combining different protocols to control a controlled device, such as an LED light fixture, present a number of challenges that adds further costs and requires additional printed circuit board (PCB) area in current designs, including the use of additional components such as expensive optically isolated relays (opto-relays).

### SUMMARY

In some embodiments, a lighting controller for controlling illumination of a lighting fixture or other controlled device containing lighting includes a microcontroller, two or more dimming circuits, a digital addressable lighting interface (DALI) bus, and a multiplexing circuit. The microcontroller controls the dimming circuits and optionally but preferably controls the multiplexing circuit. The multiplexing circuit selectively couples an output of one of the dimming circuits to a dimming output of the lighting controller responsive to receipt of a dimming control signal from the microcontroller or an external source. One dimming circuit (e.g., a first dimming circuit) utilizes a DALI protocol to produce a first dimming signal when the dimming circuit is activated by the microcontroller. The other dimming circuit (e.g., a second dimming circuit) utilizes a non-DALI dimming technology to produce a second dimming signal when the dimming circuit is activated by the microcontroller. The DALI bus is the pathway over which direct current (DC) power is supplied to at least the first dimming circuit and that is used by the first dimming circuit to communicate the first dimming signal to the lighting fixture. The multiplexing circuit includes a first set of diodes to isolate the second dimming circuit from the DALI bus when the second dimming circuit is deactivated and the first dimming circuit is activated. Additionally, the first dimming circuit includes a second set of diodes to isolate the second dimming circuit from the DALI bus when the first dimming circuit is deactivated and the second dimming circuit is activated. The diodes of the first dimming circuit may also isolate the DALI bus from the first dimming circuit when an external DALI bus is present.

In some embodiments of the lighting controller, the non-DALI dimming technology of the second dimming circuit is pulse width modulation (PWM) dimming. In other embodiments, the non-DALI dimming technology of the second dimming circuit may be analog 0-10V dimming. In further embodiments, the non-DALI dimming technology of the second dimming circuit is one of silicone-controlled rectifier (SCR) dimming, analog 1-10V dimming, or digital multiplex (DMX) dimming. The lighting controller may include more than two dimming technologies where necessary to accommodate various types of lighting fixtures and/or other controlled gear. In such cases, the non-DALI dimming technologies used may include any two or more of the aforementioned non-DALI dimming technologies or newly developed, non-DALI dimming technologies.

In some embodiments of the multiplexing circuit, the first set of diodes includes body diodes of metal-oxide-semiconductor field-effect (MOSFET) transistors. In such embodiments and others, the first set of diodes may also isolate the DALI bus from a DALI interface when an external DALI bus supply is provided by the lighting fixture or other controlled device or gear. In some embodiments, the multiplexing circuit also isolates the first dimming circuit from the second dimming circuit.

In some embodiments, the microcontroller senses or detects the type of external dimming interface that is in use by the lighting fixture or other controlled gear to which the lighting controller is coupled and controls the multiplexing circuit to activate the first dimming circuit or the second dimming circuit depending upon which type of external dimming interface is sensed. In such embodiments and others, the microcontroller may be configured to always activate the first dimming circuit without a DALI bus supply to check if the lighting fixture or other controlled device has a DALI driver. If a DALI protocol communication is established between the microcontroller and the lighting fixture or other controlled gear, the microcontroller activates the first dimming circuit. If the microcontroller detects that the lighting fixture has a PWM dimming type LED driver, the microcontroller activates the second dimming circuit, where the second dimming circuit uses PWM dimming technology.

In some embodiments, the lighting controller further includes a light sensor and/or a timing schedule database coupled to the microcontroller. In such embodiments, the microcontroller activates or deactivates the first dimming circuit or the second dimming circuit, as previously determined to be the correct one to use or is already in use, based on the output of the light sensor (e.g., indicating dawn or dusk) and/or based on a time schedule stored in the time scheduling database. Use of a time schedule for lighting control provides more precise control than merely using an ambient light sensor.

In some, more particular embodiments, a lighting controller for controlling a controlled device such as a lighting fixture includes a microcontroller, two or more dimming circuits, a DALI bus, and a multiplexing circuit. The microcontroller controls the dimming circuits and optionally but preferably controls the multiplexing circuit. The multiplexing circuit is operable to selectively couple an output of one of the dimming circuits to a dimming output of the lighting controller (corresponding to a dimming input of the controlled device) responsive to receipt of a dimming control signal from the microcontroller or an external source. One dimming circuit (e.g., a first dimming circuit) utilizes a DALI protocol to produce a first dimming signal when the dimming circuit is activated by the microcontroller. Another dimming circuit (e.g., a second dimming circuit) utilizes PWM technology to implement 0-10V dimming to produce a second dimming signal when the dimming circuit is activated by the microcontroller. When included, a third dimming circuit may utilize another non-DALI dimming technology, such as analog 0-10V or 1-10V dimming, to produce a third dimming signal when the dimming circuit is activated by the microcontroller. The DALI bus is the pathway over which DC power is supplied to at least the DALI dimming circuit and that is used by the DALI dimming circuit to communicate the first dimming signal to the controlled device. The multiplexing circuit includes a first set of diodes to isolate the 0-10V dimming circuit from the DALI bus when the DALI dimming circuit is activated and the 0-10V dimming circuit is deactivated. Additionally, the DALI dimming circuit includes a second set of diodes to isolate the 0-10V dimming circuit from the DALI bus when the DALI dimming circuit is deactivated and the 0-10V dimming circuit is activated. The diodes of the DALI dimming circuit may also isolate the DALI bus from the DALI dimming circuit when an external DALI bus is present.

In some embodiments, the lighting controller further includes a light sensor and/or a timing schedule database coupled to the microcontroller. In such embodiments, the microcontroller activates or deactivates the first dimming circuit or the second dimming circuit, as previously determined to be the correct one to use or is already in use, based on the output of the light sensor (e.g., indicating dawn or dusk) and/or based on a time schedule stored in the time scheduling database.

In some embodiments of the multiplexing circuit, the first set of diodes includes body diodes of metal-oxide-semiconductor field-effect (MOSFET) transistors. In such embodiments and others, the first set of diodes may also isolate the DALI bus from a DALI interface when an external DALI bus supply is provided by the controlled device. In some embodiments, the multiplexing circuit also isolates the first dimming circuit from the second dimming circuit.

In some embodiments, the microcontroller senses or detects the type of external dimming interface that is in use by the controlled device to which the lighting controller is coupled and controls the multiplexing circuit to activate the DALI dimming circuit or the 0-10V dimming circuit depending upon which type of external dimming interface is sensed. In such embodiments and others, the microcontroller may be configured to always activate the first dimming circuit without a DALI bus supply to check if the controlled device has a DALI driver. If a DALI protocol communication is established between the microcontroller and the controlled device, the microcontroller activates the DALI dimming circuit. If the microcontroller detects that the lighting fixture has a PWM dimming type LED driver, the microcontroller activates the 0-10V dimming circuit, where the second dimming circuit uses PWM dimming technology to implement 0-10V dimming for an LED driver.

In some embodiments, a method of controlling a controlled device may include steps of producing a first dimming signal using a DALI protocol when a microcontroller activates a first dimming circuit, producing a second dimming signal using a non-DALI technology when the microcontroller activates a second dimming circuit, supplying direct current power to at least the first dimming circuit using a DALI bus that is further used by the first dimming circuit to communicate the first dimming signal to the controlled device, and multiplexing the first and second dimming circuits using a multiplexing circuit for coupling an output of one of the first dimming circuit and the second dimming circuit to a dimming output responsive to receipt of a dimming control signal, the multiplexing circuit including a first set of diodes to isolate the second dimming circuit from the DALI bus when the second dimming circuit is deactivated and the first dimming circuit is activated. In some embodiments, the first dimming circuit includes a second set of diodes to isolate the second dimming circuit from the DALI bus when the first dimming circuit is deactivated and the second dimming circuit is activated.

In some embodiments, the method includes using a light sensor coupled to the microcontroller to control a plurality of light emitting diodes serving as the controlled device. In such embodiments and others, the method may include using a time schedule stored in a time scheduling database to control lighting of the controlled device.

### BRIEF DESCRIPTION OF THE DRAWINGS

Non-limiting and non-exhaustive embodiments are described with reference to the following drawings, in which like reference numerals refer to like parts throughout the various views, unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings.

FIG. 1 is a high-level electrical block diagram of a system including a lighting controller that multiplexes application of different dimming circuits to control a controlled device such as a lighting fixture in accordance with exemplary embodiments of the present disclosure.

FIG. 2 is a more detailed electrical block diagram of an exemplary system including a lighting controller that multiplexes a DALI dimming circuit and a 0-10V dimming circuit to control a controlled device such as a lighting fixture in accordance with exemplary embodiments of the present disclosure.

### DETAILED DESCRIPTION

In the following description, certain exemplary embodiments are disclosed to provide an understanding of the subject matter set forth in the appended claims. However, one skilled in the relevant art will recognize that the disclosed embodiments and other embodiments may be practiced without one or more of the methods, components, or materials set forth herein, or with other methods, components, or materials. Additionally, in the present disclosure and the accompanying figures, well-known structures have been omitted or shown and described in reduced detail to avoid unnecessarily obscuring descriptions and illustrations of the disclosed exemplary embodiments.

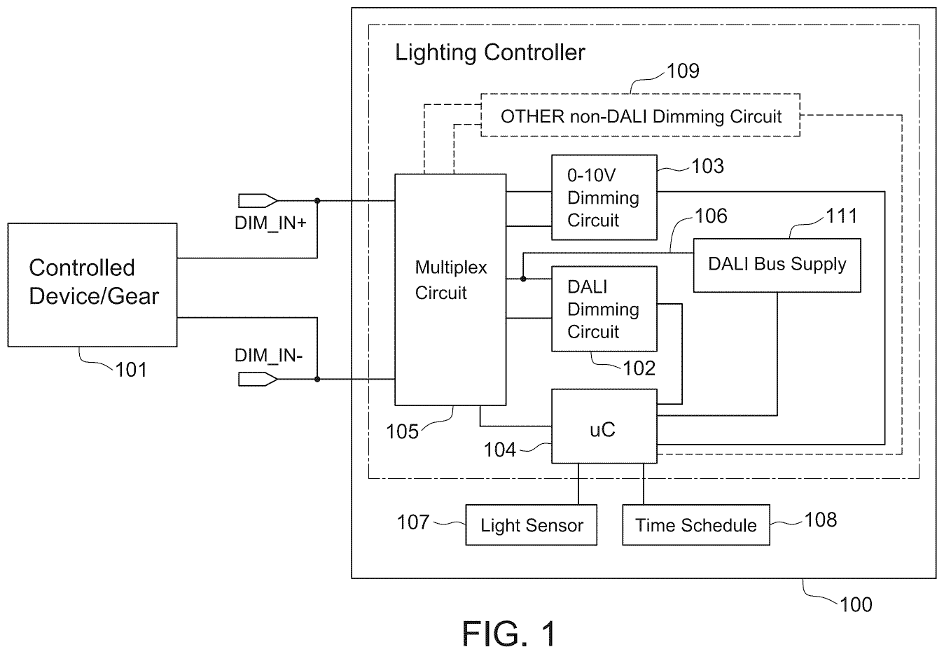

FIG. 1 is a high-level electrical block diagram of a system including a lighting controller 100 controlling illumination of a lighting fixture (e.g., an outdoor, roadway, streetlight or other lighting fixture) or other controlled device 101 containing lighting, which multiplexes application of different dimming circuits to control such illumination in accordance with exemplary embodiments of the present disclosure. The lighting controller 100 includes a microcontroller 104, two or more dimming circuits 102, 103, 109 (three shown for illustration but only two will be discussed with reference to FIG. 1), a DALI bus 106, and a multiplexing circuit 105. The microcontroller 104 is operable to control the dimming circuits 102, 103, 109 and optionally but preferably controls the multiplexing circuit 105.

The multiplexing circuit 105 selectively couples an output of one of the dimming circuits 102, 103, 109 to a dimming output (DIM_IN+, DIM_IN−) of the lighting controller 100 responsive to receipt of a dimming control signal from the microcontroller 104 or an external source. One dimming circuit 102 utilizes a DALI protocol to produce a dimming signal when the dimming circuit 102 is activated by the microcontroller 104. The other dimming circuit 103, 109 utilizes a non-DALI dimming technology to produce a dimming signal when the other dimming circuit 103, 109 is activated by the microcontroller 104. The DALI bus 106 is the pathway over which DC power is supplied from a DALI bus supply 111 to at least the DALI dimming circuit 102 (e.g., when an external DALI bus is not supplied from the control device 101) and that is used by the DALI dimming circuit 102 to communicate its dimming signal to the controlled device 101 (which is also coupled to the DALI bus).

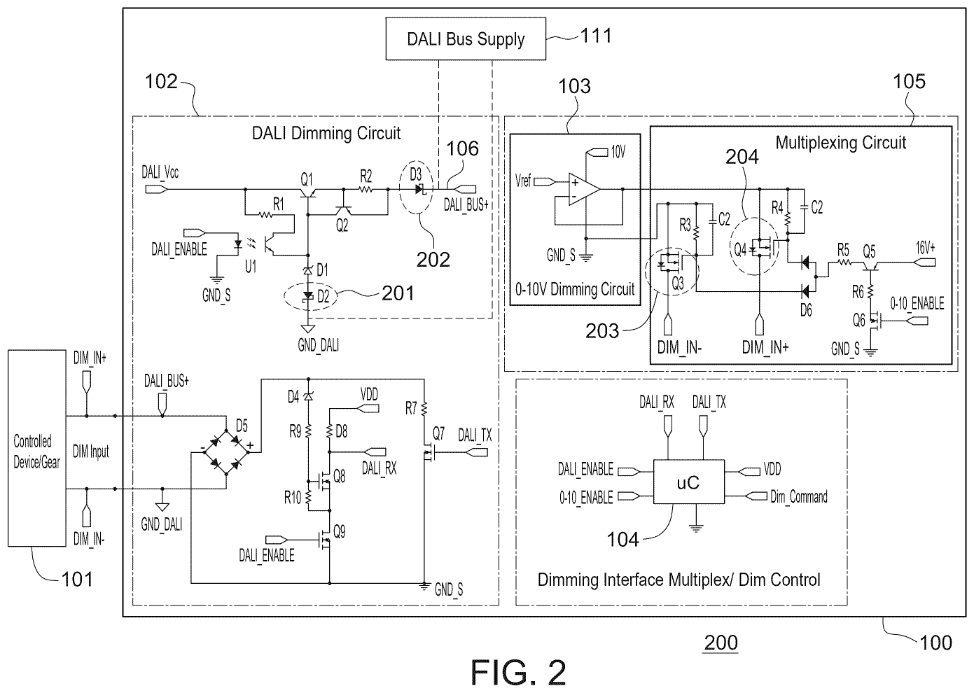

As will be described in more detail below with respect to FIG. 2, the multiplexing circuit 105 includes a first set of diodes to isolate the non-DALI dimming circuit 103, 109 from the DALI bus 106 when the non-DALI dimming circuit 103, 109 is deactivated and the DALI dimming circuit 102 is activated. Additionally, the DALI dimming circuit 102 includes a second set of diodes to isolate the non-DALI dimming circuit 103, 109 from the DALI bus 106 when the DALI dimming circuit 102 is deactivated and the non-DALI dimming circuit 103, 109 is activated. The diodes of the DALI dimming circuit 102 may also isolate the DALI bus 106 from the DALI dimming circuit 102 when an external DALI bus is present.

In some embodiments of the lighting controller 100, the dimming technology of non-DALI dimming circuit 103 is PWM-implemented 0-10V dimming, where the controlled device 101 includes LED lighting. Alternatively, the dimming technology of the non-DALI dimming circuit 109 may be analog 0-10V or 1-10V dimming, silicone-controlled rectifier (SCR) dimming, or digital multiplex (DMX) dimming. The lighting controller 100 may include more than two dimming technologies where necessary to accommodate various types of lighting fixtures and/or other controlled gear 101. In such cases, the non-DALI dimming technologies used may be any of the aforementioned non-DALI dimming technologies or newly developed, non-DALI dimming technologies.

In some embodiments, the lighting controller 100 further includes a light sensor 107 and/or a timing schedule database 108 coupled to the microcontroller 104. In such embodiments in which the light sensor 107 is used, the microcontroller 104 activates or deactivates, as appropriate, the selected dimming circuit 102, 103, as detailed above and below, based on the output of the light sensor 107. For example, when the light sensor 107 indicates its dusk, the microcontroller 104 activates the selected dimming circuit 102, 103 to turn the lighting of the controlled device 101 on. When the light sensor 107 indicates its dawn, the microcontroller 104 deactivates the currently active dimming circuit 102, 103 to turn the lighting of the controlled device 101 off.

In such embodiments in which a timing schedule database 108 is used and time is supplied to the microcontroller 104 by a global positioning satellite receiver (not shown) or other timing circuit providing the current time of day, the microcontroller 104 activates or deactivates, as appropriate, the selected dimming circuit 102, 103, as detailed above and below, according to the time schedule stored in the timing schedule database 108. For example, when the stored time schedule provides for the lighting of the controlled device 101 to be on during a first time period and off during a second time period, the microcontroller 104 activates the selected dimming circuit 102, 103 to turn the lighting of the controlled device 101 on at the beginning of the first time period and deactivates the currently active dimming circuit 102, 103 to turn the lighting of the controlled device 101 off at the beginning of the second time period.

Referring now to FIG. 2, a more detailed system 200 is illustrated in block diagram and schematic forms depicting an exemplary embodiment of the lighting controller 100. In the exemplary embodiment of FIG. 2, the multiplexing circuit 105 includes a first set of diodes 203, 204 to isolate the 0-10V dimming circuit 103 from the DALI bus 106 when the 0-10V dimming circuit 103 is deactivated and the DALI dimming circuit 102 is activated. In some embodiments, the DALI dimming circuit 102 includes a second set of diodes 201, 202 to isolate the 0-10V dimming circuit 103 from the DALI bus 106 when the DALI dimming circuit 102 is deactivated and the 0-10V dimming circuit 103 is activated. The second set of diodes 201, 202 may also isolate the DALI bus 106 from a DALI dimming interface when the internal DALI bus is not needed due to the presence of an external DALI bus (such as a DALI bus supplied by the controlled device 101).

With respect to the isolation between dimming circuits, the second set of diodes 201, 202 isolate the DALI bus 106 from the PWM-implemented 0-10V dimming circuit 103 when the 0-10V dimming circuit 103 is activated (i.e., on). The second set of diodes 201, 202 also isolate the DALI dimming circuit 102 from the DALI bus 106 when an external DALI bus is provided by the controlled device/gear 101.

Operationally, the multiplexing circuit 105 is controlled by the microprocessor or microcontroller (uC) 104. Set of diodes 203, 204 serve as the main isolation control devices in the multiplexing circuit 105. Accordingly, when the multiplexing circuit 105 enables the isolation diodes 203, 204, PWM-implemented 0-10V dimming is activated and connected to the controlled device 101 through the dimming output of the lighting controller 100, which is connected to the dimming input of the controlled device 101 (DIM_IN+ and DIM_IN−). When the multiplexing circuit 105 disables the isolation diodes 203, 204, the DALI dimming circuit 102 is activated and the 0-10V dimming circuit 103 is electrically disconnected from the dimming output of the lighting controller 100 (DIM_IN+/DIM_IN−). Therefore, the multiplexing circuit 105 isolates the 0-10V dimming circuit 103 from the DALI dimming circuit 102.

In some embodiments, the isolation diodes 203, 204 may be body diodes of a power metal-oxide-semiconductor field-effect transistor (MOSFET) or may be implemented with a diode in parallel with another field-effect transistor (FET), a bipolar junction transistor (BJT), or other type of transistor. Where MOSFETs are used to implement the multiplexing circuit's isolation diodes 203, 204, when the microcontroller 104 brings its 0-10_Enable pin low (OFF), the multiplexing circuit's MOSFETs 203, 204 isolate the 0-10V dimming circuit output from the DALI dimming circuit 102 (i.e., deactivate the 0-10V dimming circuit 103).

The 0-10_Enable signal controls the multiplexing circuit 105 to activate/deactivate the PWM-implement 0-10V dimming circuit 103. When deactivated, 0-10V dimming circuit 103 is isolated from DALI bus 106 and all external control by the body diodes of the MOSFETs 203, 204.

In some embodiments, the microcontroller 104 can sense the type of external dimming interface of the controlled device 101 and controls the multiplexing circuit 105 to activate the 0-10V dimming circuit 103 (or other non-DALI dimming circuit(s) 109) or the DALI dimming circuit 102 depending upon which dimming interface is detected.

In some embodiments, the microcontroller 104 initially activates the DALI dimming circuit 102 without a DALI bus supply 111 to check if the dimming interface of the controlled device 101 includes an LED driver that uses a DALI protocol. If a DALI communication is established, the microcontroller 104 activates the DALI dimming circuit 102. In these embodiments, the DALI bus supply 111 will be initially disabled. If there is no DALI communication established between the microcontroller 104 and the controlled device 101, the microcontroller 104 will enable the DALI bus supply 106 and try to establish DALI communication again. Note that the DALI dimming circuit 102 may have two parts, the DALI bus supply 111 and a DALI communication circuit (receive (RX) and transmit (TX) circuits, where the microcontroller 104 tries to establish communication through the TX and RX circuits).

If a DALI communication is established, the microcontroller 104 activates the DALI dimming circuit 102 or, if the DALI dimming circuit 102 is already active, keeps the DALI dimming circuit 102 activated. If there is still no DALI communication established, the microcontroller 104 sets DALI_TX high to short the lighting controller's dimming output (DIM_IN+ and DIM_IN−) to determine if the controlled device 101 responds to the dimming interface short.

If the controlled device 101 is a PWM dimming type LED driver, the controlled device 101 will go to minimum dimming with an electrically shorted dimming input (DIM_IN+ and DIM_IN−). Accordingly, if the microcontroller 104 senses the controlled device 101 responds to shorting of the dimming interface, the microcontroller 104 activates the PWM-implemented 0-10V dimming circuit 103.

The lighting controller 100 can be used for lighting control of any controlled device 101 provided that the lighting controller 100 includes both a DALI dimming circuit 102 and the required non-DALI dimming circuit 109 for the controlled device to which it is connected. In some embodiments, the dimming technology of the non-DALI dimming circuit 103 is PWM and in other embodiments the dimming technology of the second non-DALI dimming circuit 109 is analog 0-10V dimming, analog 1-10V dimming, SCR dimming, or DMX dimming.

In some embodiments as noted above, the multiplexing circuit's set of isolation diodes 203, 204 are implemented as body diodes of MOSFET transistors. In those and other embodiments, the multiplexing circuit's set of diodes 203, 204 isolate the DALI bus 106 from a DALI interface when an external DALI bus supply is provided by the light fixture or controlled device 101. In some embodiments, the multiplexing circuit 105 isolates the DALI dimming circuit 102 from the non-DALI dimming circuit 103, 109.

In some embodiments, a method of controlling a controlled device 101 may include the steps of producing a first dimming signal using DALI technology when a microcontroller 104 activates a first dimming circuit 102, producing a second dimming signal using non-DALI technology (e.g., PWM dimming or an analog 0-10V dimming technology) when the microcontroller activates a second dimming circuit 103, 109, supplying direct current power to at least the first dimming circuit 102 using a DALI bus 106 that is further used by the first dimming circuit 102 to communicate the first dimming signal to the controlled device 101, and multiplexing the first and second dimming circuits 102, 103, 109 using a multiplexing circuit 105 for coupling an output of one of the first dimming circuit 102 and the second dimming circuit 103, 109 to a dimming output/controlled device dimming input (DIM_IN+ and DIM_IN−) responsive to receipt of a dimming control signal, the multiplexing circuit 105 including a first set of diodes 203, 204 to isolate the second dimming circuit 103, 109 from the DALI bus 106 when the second dimming circuit 103, 109 is de-activated and the first dimming circuit 102 is activated. In some embodiments, the first dimming circuit 102 includes a second set of diodes 203, 204 to isolate the second dimming circuit 103, 109 from the DALI bus 106 when the first dimming circuit 102 is deactivated, and the second dimming circuit 103, 109 is activated.

In some embodiments, the method further isolates the first dimming circuit 102 by using a set of diodes 203, 204 to isolate the DALI bus 106 from the second dimming circuit 103, 109 when the DALI bus 106 is inactive.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, an electronic device may be described as being mounted “substantially vertical.” In such a case, a device that is mounted exactly vertical is mounted along a “Y” axis and a “X” axis that is normal (i.e., 90 degrees or at right angle) to a plane or line formed by a “Z” axis. Different from the exact precision of the term, “vertical,” the use of “substantially” or “about” to modify the characteristic permits a variance of the particular characteristic by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning “and/or. ” The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,“ are to be construed in an open, inclusive sense (e.g., ”including, but not limited to”). Additionally, in this disclosure, the singular shall mean the plural and vice versa, unless expressly stated otherwise.

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items and one or more other alternative embodiments that include fewer than all of the associated items.

The various embodiments described above can be combined to provide further embodiments. Aspects of the embodiments can be modified, if necessary to employ concepts of the various patents, application and publications to provide further embodiments.

What is claimed is:

1. A lighting controller for controlling illumination of a lighting fixture, the lighting controller comprising:
a microcontroller;
a first dimming circuit that, when activated by the microcontroller, utilizes a digital addressable lighting interface (DALI) protocol to produce a first dimming signal;
a second dimming circuit that, when activated by the microcontroller, utilizes a non-DALI dimming technology to produce a second dimming signal;
a DALI bus over which direct current power is supplied to at least the first dimming circuit and that is used by the first dimming circuit to communicate the first dimming signal to the lighting fixture; and
a multiplexing circuit operable to selectively couple an output of either the first dimming circuit or the second dimming circuit to a dimming output responsive to receipt of a dimming control signal, the multiplexing circuit including a first set of diodes to isolate the second dimming circuit from the DALI bus when the second dimming circuit is deactivated and the first dimming circuit is activated;
wherein the first dimming circuit includes a second set of diodes to isolate the second dimming circuit from the DALI bus when the first dimming circuit is deactivated and the second dimming circuit is activated.

2. The lighting controller of claim 1, wherein the second set of diodes further isolates the DALI bus from the first dimming circuit when an external DALI bus is present.

3. The lighting controller of claim 1, wherein the non-DALI dimming technology of the second dimming circuit is pulse width modulation (PWM) dimming.

4. The lighting controller of claim 1, wherein the non-DALI dimming technology of the second dimming circuit is analog 0-10V dimming.

5. The lighting controller of claim 1, wherein the first set of diodes includes body diodes of metal-oxide-semiconductor field-effect (MOSFET) transistors.

6. The lighting controller of claim 1, wherein the first set of diodes isolate the DALI bus from a DALI interface when an external DALI bus supply is provided by the lighting fixture.

7. The lighting controller of claim 1, wherein the multiplexing circuit is controlled by the microcontroller.

8. The lighting controller of claim 1, wherein the multiplexing circuit isolates the first dimming circuit from the second dimming circuit.

9. The lighting controller of claim 1, wherein the microcontroller senses a type of external dimming interface that is in use by the lighting fixture and controls the multiplexing circuit to activate the first dimming circuit or the second dimming circuit depending upon which type of external dimming interface is sensed.

10. The lighting controller of claim 1, wherein the microcontroller is configured to always activate the first dimming circuit without a DALI bus supply to check if the lighting fixture has a DALI driver.

11. The lighting controller of claim 10, wherein when a DALI protocol communication is established between the microcontroller and the lighting fixture, the microcontroller activates the first dimming circuit.

12. The lighting controller of claim 1, wherein the microcontroller activates the second dimming circuit if the lighting fixture has a PWM dimming type LED driver.

13. The lighting controller of claim 1, wherein the non-DALI dimming technology of the second dimming circuit is one of silicone-controlled rectifier dimming, analog 1-10V dimming, or digital multiplex dimming.

14. The lighting controller of claim 1, further comprising:
a light sensor coupled to the microcontroller, wherein the microcontroller activates or deactivates the first dimming circuit or the second dimming circuit based on an output of the light sensor.

15. The lighting controller of claim 1, further comprising:
a time scheduling database coupled to the microcontroller, wherein the microcontroller activates or deactivates the first dimming circuit or the second dimming circuit based on a time schedule stored in the time scheduling database.

16. A lighting controller for controlling a controlled device, the lighting controller comprising:
a microcontroller;
a first dimming circuit that, when activated by the microcontroller, utilizes a DALI protocol to produce a first dimming signal;
a second dimming circuit that, when activated by the microcontroller, utilizes pulse width modulation to implement 0-10V dimming to produce a second dimming signal;
a DALI bus over which direct current power is supplied to at least the first dimming circuit and that is used by the first dimming circuit to communicate the first dimming signal to the controlled device; and
a multiplexing circuit operable to selectively couple an output of the first dimming circuit or the second dimming circuit to a dimming output responsive to receipt of a dimming control signal, the multiplexing circuit including a first set of diodes to isolate the second dimming circuit from the DALI bus when the first dimming circuit is activated and the second dimming circuit is deactivated;
wherein the first dimming circuit includes a second set of diodes to isolate the second dimming circuit from the DALI bus when the first dimming circuit is deactivated and the second dimming circuit is activated.

17. The lighting controller of claim 16, further comprising:
a light sensor coupled to the microcontroller, wherein the microcontroller activates or deactivates the first dimming circuit or the second dimming circuit based on an output of the light sensor.

18. The lighting controller of claim 16, further comprising:
a time scheduling database coupled to the microcontroller, wherein the microcontroller activates or deactivates the first dimming circuit or the second dimming circuit based on a time schedule stored in the time scheduling database.

19. The lighting controller of claim 16, wherein the second set of diodes further isolates the DALI bus from the first dimming circuit when an external DALI bus is present.

20. The lighting controller of claim 16, wherein when a DALI protocol communication is established between the microcontroller and the controlled device, the microcontroller activates the first dimming circuit.
